(19) United States
(12) Patent Application Publication
(10) Pub. No.: US 2012/0299962 A1
(43) Pub. Date: Nov. 29, 2012

(54) METHOD AND APPARATUS FOR COLLABORATIVE AUGMENTED REALITY DISPLAYS

(75) Inventors: Sean White, Los Angeles, CA (US); Lance Williams, Toluca Lake, CA (US)

(73) Assignee: Nokia Corporation, Espoo (FI)

(21) Appl. No.: 13/117,402

(22) Filed: May 27, 2011

(51) Int. Cl. G09G 5/00

(52) U.S. Cl. 345/633

(57) ABSTRACT

Methods and apparatuses are provided for facilitating interaction with augmented reality devices, such as augmented reality glasses and/or the like. A method may include receiving a visual recording of a view from a first user from an imaging device. The method may also include displaying the visual recording to a display. Further, the method may include receiving an indication of a touch input to the display. In addition, the method may include determining, by a processor, a relation of the touch input to the display. The method may also include displaying, at least in part on the determined relation, an icon representative of the touch input to the imaging device. Corresponding apparatuses are also provided.

### TECHNOLOGICAL FIELD

Example embodiments of the present invention relate generally to user interface technology and, more particularly, relate to methods and apparatuses for facilitating interaction with a user interface, such as near-eye displays and augmented reality displays.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of functionality that only a few years ago required processing power that could be provided only by the most advanced desktop computers. Consequently, mobile computing devices having a small form factor have become ubiquitous and are used to access network applications and services.

In addition, display devices, such as projectors, monitors, or augmented reality glasses, may provide an enhanced view by incorporating computer-generated information with a view of the real world. Such display devices may further be remote wireless display devices such that the remote display device provides an enhanced view by incorporating computer-generated information with a view of the real world. In particular, augmented reality devices, such as augmented reality glasses, may provide for overlaying virtual graphics over a view of the physical world. As such, methods of navigation and transmission of other information through augmented reality devices may provide for richer and deeper interaction with the surrounding environment. The usefulness of augmented reality devices relies upon supplementing the view of the real world with meaningful and timely virtual graphics.

### BRIEF SUMMARY

Methods, apparatuses, and computer program products are herein provided for facilitating interaction via a remote user interface with a display, such as an augmented reality display, e.g., augmented reality glasses, an augmented reality near-eye display and/or the like, that may be either physically collocated or remote from a remote user interface. In one example embodiment, two or more users may interact in real-time with one user providing input via a remote user interface that defines one or more icons or other indications that are displayed upon an augmented reality display of the other user, thereby providing for a more detailed and informative interaction between the users.

In one example embodiment, a method may include receiving an image of a view of an augmented reality device. The method may also include causing the image to be displayed. Further, the method may include receiving an input indicating a respective portion of the image. In addition, the method may comprise determining, by a processor, a location of the input within the image, and causing information regarding the location of the input to be provided to the augmented reality device such that an indication may be imposed upon the view provided by the augmented reality at the location of the input.

According to one example embodiment, the method may further include receiving the image in real time so that the image that is caused to be displayed is also displayed by the augmented reality device. In another embodiment, the method may also include receiving a video recording, and causing the video recording to be displayed. According to another embodiment, the method may also include receiving the input to identify a respective feature within an image of the video recording and continuing to identify the respective feature as the image changes. The method may also include employing feature recognition to identify the respective feature within the video recording. In one embodiment, the method may include receiving an input that moves across the image so as to indicate both a location and a direction.

In another example embodiment, an apparatus may comprise at least one processor and at least one memory storing computer program code, wherein the at least one memory and stored computer program code are configured, with the at least one processor, to cause the apparatus to at least receive an image of a view of an augmented reality device. Further the apparatus may comprise at least one processor and at least one memory storing computer program code, wherein the at least one memory and stored computer program code are configured, with the at least one processor, to cause the apparatus to at least cause the image to be displayed. In addition, the apparatus may comprise at least one processor and at least one memory storing computer program code, wherein the at least one memory and stored computer program code are configured, with the at least one processor, to cause the apparatus to at least receive an input indicating a respective portion of the image. According to one embodiment, the apparatus may comprise at least one processor and at least one memory storing computer program code, wherein the at least one memory and stored computer program code are configured, with the at least one processor, to cause the apparatus to at least determine a location of the input within the image, and cause information regarding the location of the input to be provided to the augmented reality device such that an indication may be imposed upon the view provided by the augmented reality at the location of the input.

In another example embodiment, a computer program product is provided. The computer program product of the example embodiment may include at least one non-transitory computer-readable storage medium having computer-readable program instructions stored therein. The computer-readable program instructions may comprise program instructions configured to cause an apparatus to perform a method comprising receiving an image of a view from an augmented reality device. The method may also include causing the image to be displayed. Further, the method may include receiving an input indicating a respective portion of the image. In one embodiment, the method may also include determining, by a processor, a location of the input within the image, and causing information regarding the location of the input to be provided to the augmented reality device such that an indication may be imposed upon the view provided by the augmented reality at the location of the input.

In another example embodiment, an apparatus may include means for receiving an image of a view of an augmented reality device. The apparatus may also include means for causing the image to be displayed. Further, the apparatus may include means for receiving an input indicating a respective portion of the image. In addition, the apparatus may comprise means for determining, by a processor, a location of the input within the image, and causing information regarding the location of the input to be provided to the augmented reality device such that an indication may be imposed upon the view provided by the augmented reality at the location of the input.

According to another example embodiment, a method may include causing an image of a field of view of an augmented reality device to be captured. Further, the method may include causing the image to be provided to a remote user interface. In addition, the method may include receiving information indicative of an input to the remote user interface corresponding to a respective portion of the image. The method may also include causing an indicator to be provided upon the view provided by the augmented reality device based upon the information from the remote user interface.

In another example embodiment, an apparatus may comprise at least one processor and at least one memory storing computer program code, wherein the at least one memory and stored computer program code are configured, with the at least one processor, to cause the apparatus to at least cause an image of a field of view to be captured. The at least one memory and stored computer program code are configured, with the at least one processor, to cause the apparatus to at least cause the image to be provided to a remote user interface. In addition, the at least one memory and stored computer program code are configured, with the at least one processor, to cause the apparatus to at least receive information indicative of an input to the remote user interface corresponding to a respective portion of the image. The at least one memory and stored computer program code are further configured, with the at least one processor, to cause the apparatus to at least cause an indicator to be provided upon the view provided by the apparatus based upon the information form the remote user interface.

In another example embodiment, a computer program product is provided that may include at least one non-transitory computer-readable storage medium having computer-readable program instructions stored therein. The computer-readable program instructions may comprise program instructions configured to cause an apparatus to perform a method comprising causing an image of a field of view of an augmented reality device to be captured. Further, the method may include causing the image to be provided to a remote user interface. In addition, the method may include receiving information indicative of an input to the remote user interface corresponding to a respective portion of the image. The method may also include causing an indicator to be provided upon the view provided by the augmented reality device based upon the information from the remote user interface. In another example embodiment, the method may also include providing an indication of a location, object, person and/or the like a user is viewing in a field of view of an augmented reality device, such as by providing a gesture, pointing, focusing the user's gaze or other similar techniques for specifying a location, object, person and/or the like within the scene or field of view.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of a remote user interface and augmented reality display interacting via a network according to an example embodiment;

FIG. 2 is a schematic block diagram of a mobile terminal according to an example embodiment;

FIG. 3 illustrates a block diagram of an apparatus according to an example embodiment;

FIG. 4 illustrates an example interaction of an apparatus according to an example embodiment;

FIG. 5 illustrates an example interaction of an apparatus according to an example embodiment;

FIG. 6 illustrates a flowchart according to an example method for facilitating interaction with a user interface according to an example embodiment;

FIG. 7 illustrates a flowchart according to an example method for facilitating interaction with a user interface according to another example embodiment; and

FIG. 8 illustrates a flowchart according to an example method for facilitating interaction with an augmented reality device according to one embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

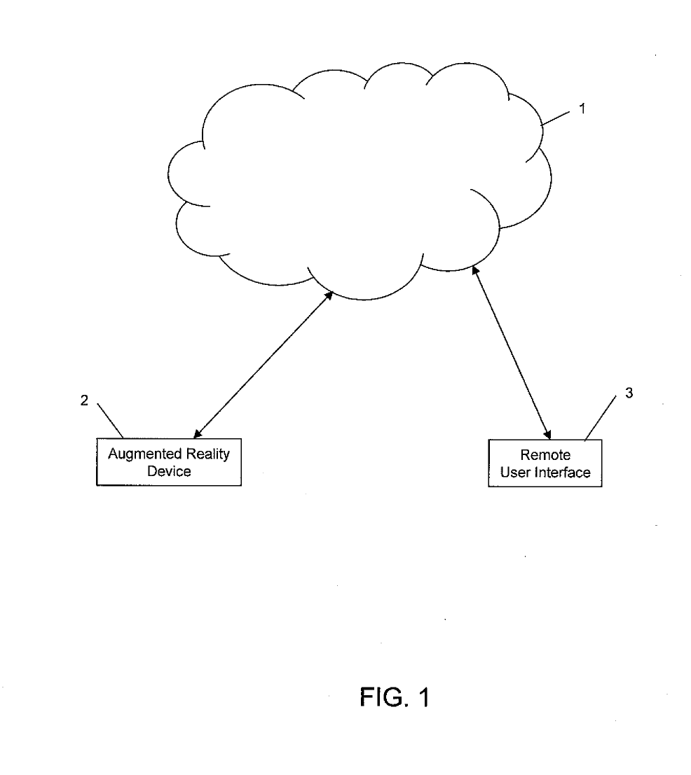

Some embodiments of the present invention may relate to a provision of a mechanism by which an augmented reality device, such as augmented reality glasses, is enhanced by the display of icons or other indications that are provided by another via a user interface that may be remote from the augmented reality device. In order to increase the relevancy of the input provided via the user interface, an image may be provided by the augmented reality device to and displayed by the remote user interface. As such, the input provided via the remote user interface may be based upon the same image, field of view, or combinations thereof as that presented by the augmented reality device such that the input and, in turn, the icons or other indications that are created based upon input and presented upon the augmented reality device may be particularly pertinent. In order to further illustrate a relationship between the augmented reality device 2 and a remote user interface 3, reference is made to FIG. 1. The augmented reality device may be any of various devices configured to present an image, field of view and/or the like that includes an image, field of view, representation and/or the like of the real world, such as the surroundings of the augmented reality device. For example, the augmented reality device may be augmented reality glasses, augmented reality near eye displays and the like. In one embodiment, augmented reality glasses may provide a visual overlay of an image (e.g., an icon or other indicator, visual elements, textual information and/or the like) on a substantially transparent display surface, such as through lenses that appear to be normal optical glass lenses. This visual overlay allows a user to view objects, people, locations, landmarks and/or the like in their typical, un-obscured field of view while providing additional information or images that may be displayed on the lenses. The visual overlay may be displayed on one or both of the lenses of the glasses dependent upon user preferences and the type of information being presented. In another embodiment, augmented reality near eye displays may provide a visual overlay of an image (e.g., an icon or other indicator, visual elements, textual information and/or the like) on an underlying image of the display. Thus, the visual overlay may allow a user to view an enhanced image of a user's surroundings or field of view (e.g., a zoomed image of an object, person, location, landmark and/or the like) concurrently with additional information or images, which may be provided by the visual overlay of the image. Further, in another embodiment of the invention, an indicator may be provided to the augmented reality device comprising spatial haptic information, auditory information and/or the like, which corresponds with an input provided to the remote user interface. The remote user interface may also be embodied by any of various devices including a mobile terminal or other computing device having a display and an associated user interface for receiving user input. Although the augmented reality device 2 and the remote user interface 3 may be remote from one another, the augmented reality device and the remote user interface may be in communication with one another, either directly, such as via a wireless local area network (WLAN), a Bluetooth™ link or other proximity based communications link, or indirectly via a network 1 as shown in FIG. 1. In this regard, the network may be any of a wide variety of different types of networks including networks operating in accordance with first generation (1G), second generation (2G), third generation (3G), fourth generation (4G) or other communications protocols, as described in more detail below.

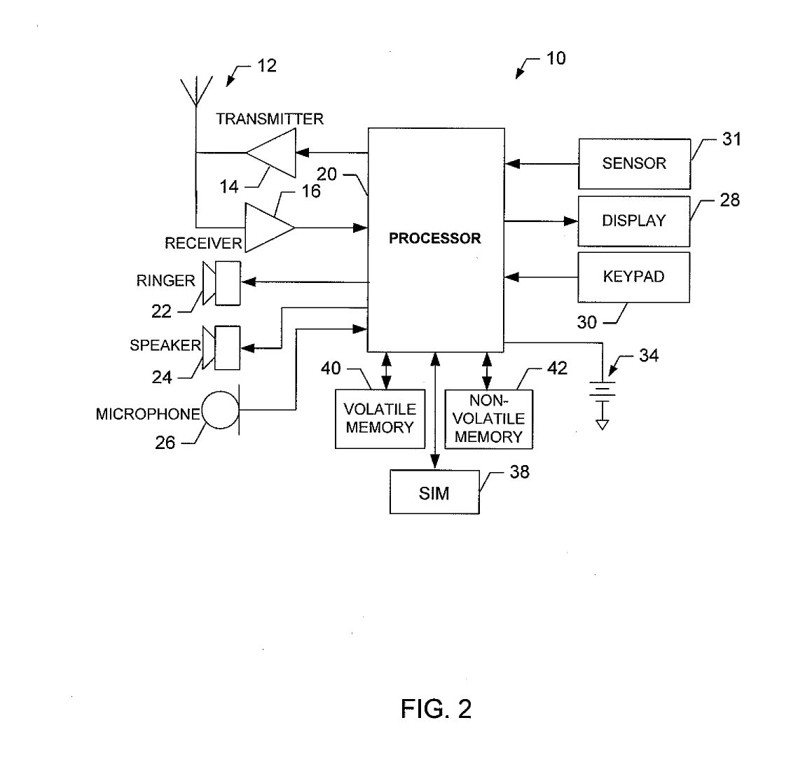

FIG. 2 illustrates a block diagram of a mobile terminal 10 that would benefit from embodiments of the present invention. Indeed, the mobile terminal 10 may serve as the remote user interface in the embodiment of FIG. 1 so as to receive user input that, in turn, is utilized to annotate the augmented reality device. It should be understood, however, that the mobile terminal 10 as illustrated and hereinafter described is merely illustrative of one type of device that may serve as the remote user interface and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local area network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display. The user input interface may comprise devices allowing the mobile terminal to receive data, such as a keypad 30, a touch display (e.g., some example embodiments wherein the display 28 is configured as a touch display), a joystick (not shown), a motion sensor 31 and/or other input device. In embodiments including a keypad, the keypad may comprise numeric (0-9) and related keys (#, *), and/or other keys for operating the mobile terminal.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

In some example embodiments, one or more of the elements or components of the remote user interface 3 may be embodied as a chip or chip set. In other words, certain elements or components may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In the embodiment of FIG. 2 in which the mobile terminal 10 serves as the remote user interface 3, the processor 20 and memories 40, 42 may be embodied as a chip or chip set. The remote user interface 3 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein.

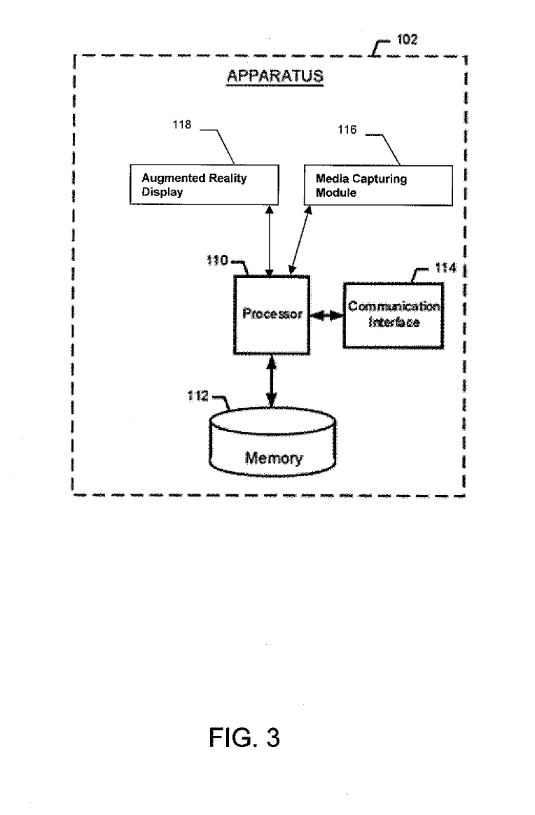

FIG. 3 illustrates a block diagram of an apparatus 102 embodied as or forming a portion of an augmented reality device 2 for interacting with the remote user interface 3, such as provided by the mobile terminal 10 of FIG. 2, for example, and providing an augmented reality display according to an example embodiment. Further, although the apparatus 102 illustrated in FIG. 3 may be sufficient to control the operations of an augmented reality device according to example embodiments of the invention, another embodiment of an apparatus may contain fewer pieces thereby requiring a controlling device or separate device, such as a mobile terminal according to FIG. 2, to operatively control the functionality of an augmented reality device, such as augmented reality glasses. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 3 illustrates one example of a configuration of an apparatus for providing an augmented reality display, other configurations may also be used to implement embodiments of the present invention.

The apparatus 102 may be embodied as various different types of augmented reality devices including augmented reality glasses and near eye displays. Regardless of the type of augmented reality device 2 in which the apparatus 102 is incorporated, the apparatus 102 of FIG. 3 includes various means for performing the various functions herein described. These means may comprise one or more of a processor 110, memory 112, communication interface 114 and/or augmented reality display 118.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 3 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 3 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like.

As shown in FIG. 3, the apparatus 102 may also include a media item capturing module 116, such as a camera, video and/or audio module, in communication with the processor 110. The media item capturing module 116 may be any means for capturing images, video and/or audio for storage, display, or transmission. For example, in an exemplary embodiment in which the media item capturing module 116 is a camera, the camera may be configured to form and save a digital image file from an image captured by the camera. The media item capturing module 116 may be configured to capture media items in accordance with a number of capture settings. The capture settings may include, for example, focal length, zoom level, lens type, aperture, shutter timing, white balance, color, style (e.g., black and white, sepia, or the like), picture quality (e.g., pixel count), flash, red-eye correction, date, time, or the like. In some embodiments, the values of the capture settings (e.g., degree of zoom) may be obtained at the time a media item is captured and stored in association with the captured media item in a memory device, such as, memory 112.

The media item capturing module 116 can include all hardware, such as a lens or other optical component(s), and software necessary for creating a digital image file from a captured image. The media item capturing module 116 may also include all hardware, such as a lens or other optical component(s), and software necessary to provide various media item capturing functionality, such as, for example, image zooming functionality. Image zooming functionality can include the ability to magnify or de-magnify an image prior to or subsequent to capturing an image.

Alternatively or additionally, the media item capturing module 116 may include only the hardware needed to view an image, while a memory device, such as the memory 112 of the apparatus 102 stores instructions for execution by the processor 110 in the form of software necessary to create a digital image file from a captured image. In an example embodiment, the media item capturing module 116 may further include a processor or co-processor which assists the processor 110 in processing image data and an encoder and/or decoder for compressing and/or decompressing image data. The encoder and/or decoder may encode and/or decode according to, for example, a joint photographic experts group (JPEG) standard or other format.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices, such as the remote user interface 3, e.g., mobile terminal 10. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to transmit an image that has been captured by the media item capturing module 116 over the network 1 to the remote user interface 3, such as in real time or near real time, and to receive information from the remote user interface regarding an icon or other indication to be presented upon the augmented reality display 118, such as to overlay the image that has been captured and/or overlay an image to the field of view of an augmented reality device, such as augmented reality glasses. The communication interface 114 may additionally be in communication with the memory 112, the media item capturing module 116 and the augmented reality display 118, such as via a bus.

In some example embodiments, the apparatus 102 comprises an augmented reality display 118. The augmented reality display 118 may comprise any type of display, near-eye display, glasses and/or the like capable of displaying at least a virtual graphic overlay on the physical world. The augmented reality display 118 may also be configured to capture an image or a video of a forward field of view when a user engages the augmented reality display, such as with the assistance of the media item capturing module 116. Further, the augmented reality display may be configured to capture an extended field of view by sweeping a media item capturing module 116, such as a video camera and/or the like, over an area of visual interest, and compositing frames from such a sweep sequence in registration, by methods well-known in the art of computer vision, so as to provide display and interaction, including remote guidance, such as from a remote user interface, over a static image formed of an area of visual interest larger than that captured continuously by the media item capturing module. As such, an augmented reality device 2 of FIG. 1 may provide a remote user interface 3 with a larger context for identification, navigation and/or the like. Registration and compositing of a sequence of frames may be performed either by the augmented reality device, such as with the assistance of at least a processor 110, or by the remote user interface.

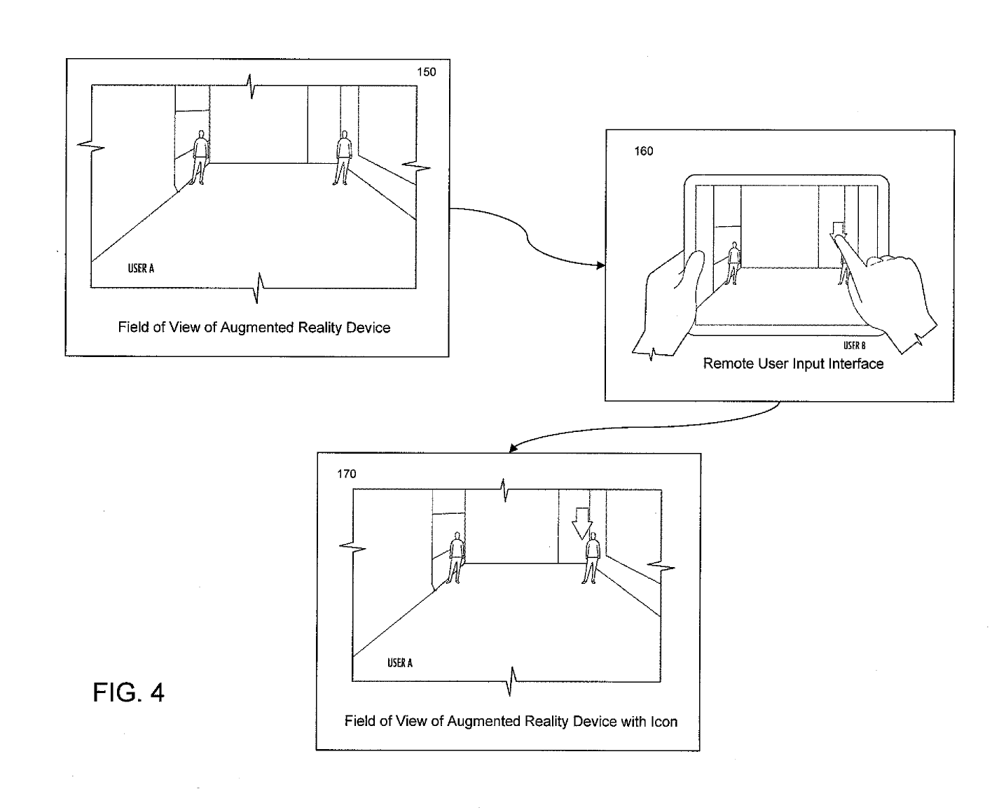

According to one embodiment, the augmented reality device 2 may be configured to display an image of the field of view of the augmented reality device 2 along with an icon or other indication representative of an input to the remote user interface 3 with the icon or other indication being overlaid, for example, upon the image of the field of view. In one embodiment, a first user may wear an augmented reality device 2, such as augmented reality glasses, augmented reality near-eye displays and/or the like, while a second user interacts with a remote user interface 3. In another embodiment, a first user may engage an augmented reality device 2, and a plurality of users may interact with a plurality of remote user interfaces. Further still, a plurality of users may engage a plurality of augmented reality devices and interact with at least one user, who may be interacting with a remote user interface. The one or more users interacting with the remote user interface may provide separate inputs to separate remote user interfaces, share a cursor displayed on separate remote user interfaces representing a single input and/or the like. As previously mentioned and as shown at 150 in FIG. 4, the augmented reality device 2, such as the media item capturing module 116, may be configured to capture an image, such as a video recording, of the first user's field of view, e.g., forward field of view. According to one embodiment, the image may be displayed, streamed and/or otherwise provided, such as via the communication interface 114, to a remote user interface 3 of the second user. As such, in one embodiment of the present invention, the second user may view the same field of view as that viewed by the first user from the image displayed, streamed and/or otherwise provided, such as by viewing a live video recording of the first user's field of view. In one embodiment of the present invention, the second user may interact with the remote user interface, such as providing a touch input in an instance in which the image is present upon a touch screen or by otherwise providing input, such as via placement and selection of a cursor as shown by the arrow at 160 in FIG. 4. The remote user interface 3, such as the processor 110, may determine the coordinates of the input relative to the displayed image and may, in turn, provide information to the augmented reality device 2 indicative of the location of the input. The augmented reality device 2 may, in turn, cause an icon or other indication to be displayed, such as by being overlaid upon the field of view, as shown at 170 in FIG. 4. In another embodiment, the augmented reality device 2 may, in turn, cause an icon or other indication to be overlaid upon an image of the field of view of the augmented reality device. The icon or other indication can take various forms including a dot, cross, a circle or the like to mark a location, an arrow to indicate a direction or the like. As such, the second user can provide information to the first user of the augmented reality device 2 based upon the current field of view of the first user.

Although a single icon is shown in the embodiment of FIG. 4, the remote user interface 3 may be configured to provide and the augmented reality device 2 may be configured to display a plurality of icons or other indications upon the underlying image. Further still, according to one embodiment, although the remote user interface 3 may be configured to receive input that identifies a single location, the remote user interface may also be configured to receive input that is indicative of a direction, such as a touch gesture in which a user directs their finger across a touch display. In this example embodiment, the augmented reality device 2 may be configured to display an icon or other indication in the form of an arrow or other directional indicator that is representative fashion of the touch gesture or continuous touch movement.

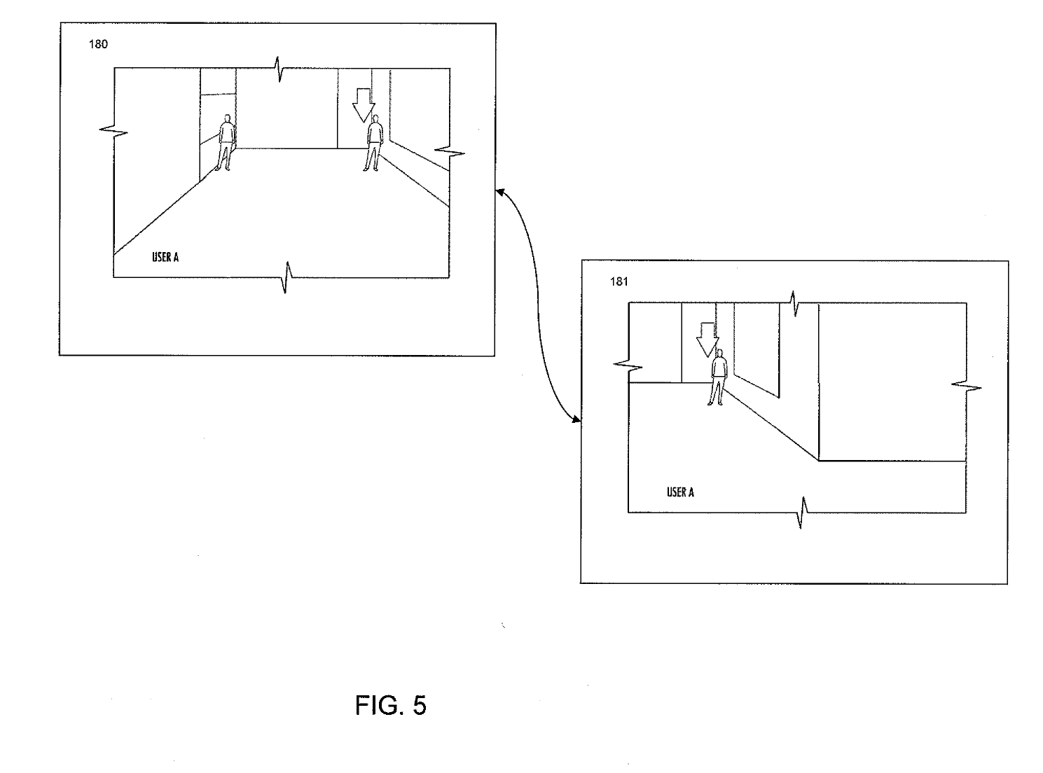

In one embodiment of the present invention, as shown in FIG. 5, the first user may rotate and/or move their head in a plurality of directions or orientations while wearing the augmented reality device 2. Further, the remote user interface, which may be carried remotely by the second user, may be configured to display the live video recording or at least a series of images illustrating such head rotation and/or movement. In this embodiment, if the second user wishes to provide an input that remains at the same location within the scene, field of view and/or the like viewed by the first user, the second user may provide an input that follows that same location across the display of the user interface, such as by moving their finger across the touch display, in order to provide a “stationary” touch input. Accordingly, the first user may then rotate and/or move their head in a plurality of directions or orientations while wearing the augmented reality device 2 such that the augmented reality device may display an icon or other indication that remains at a same position corresponding to a feature, such as the same building, person, or the like as the field of view of the augmented reality changes. As such, a first user wearing an augmented reality device may view a scene, field of view and/or the like with an icon or other indicator displayed corresponding to a person initially located on the right side of the field of view, as shown at 180 in FIG. 5. As the first user rotates his head to the right, the icon or other indicator displayed corresponding to the person remains stationary with respect to the person as the scene, field of view and/or the like rotates, as shown at 181 in FIG. 5. Accordingly, the icon or other indicator displayed corresponding to the person will appear on the left portion of the scene, field of view and/or the like of the augmented reality device when the first user has rotated his head accordingly.

Alternatively, the second user may provide input at the desired location in one of the images and may indicate that the same location is to be tracked in the other images. Based upon image recognition, feature detection or the like, the processor 110 of the remote user interface 3 may identify the same location, such as the same building, person or the like in the other images such that an icon or other indication may be imposed upon the same building, person or the like in the series of images, the scene and/or field of view displayed by the augmented reality device 2. In another embodiment, local orientation tracking and/or the like may provide an icon or other indication to remain in a correct location relative to a user viewing the augmented reality device. Further, in another embodiment, the icon or other indication may be imposed upon the same building, person or the like in the series of images, the scene and/or field of view displayed by the augmented reality device such that the icon or other indication may not be displayed by the augmented reality device when the building, person, or the like associated with the icon or other indication is not present within the series of images, the scene and/or field of view displayed by the augmented reality device and may be displayed when the building, person or the like is present within the series of images, the scene and/or field of view.

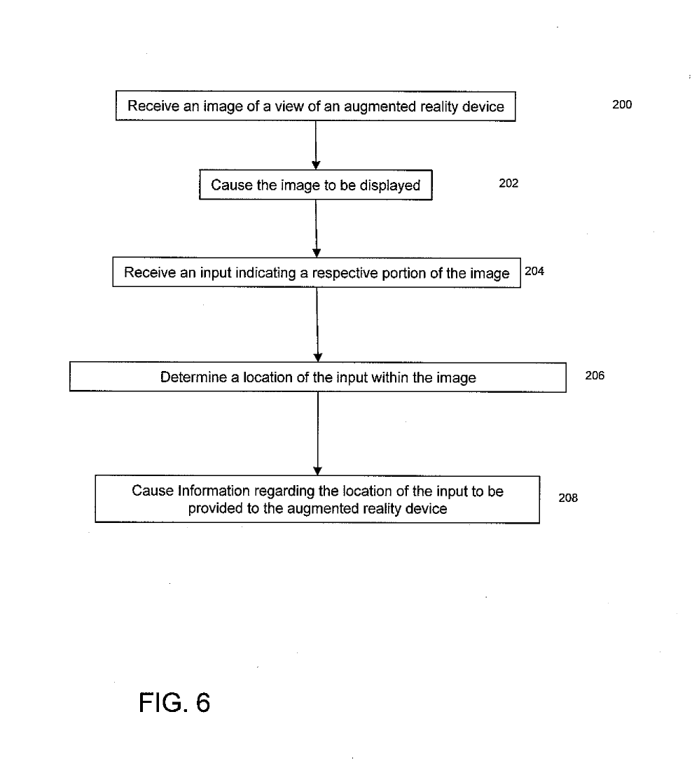

Referring now to FIG. 6, FIG. 6 illustrates an example interaction with an example augmented reality display and user interface according to an example embodiment. A user may engage an imaging device, such as an imaging device comprising an augmented reality glasses and a camera configured to visually record the forward field of view of the augmented reality glasses. One embodiment of the invention may include receiving an image of a view of an augmented reality device, such as augmented realty glasses and a camera configured to visually record the forward field of view of the augmented reality glasses. See operation 200. Further, another embodiment may include causing the image to be displayed to a touch display and/or the like. See operation 202. A second user may then provide a touch input, touch gesture input and/or the like to the touch display, which may be configured to receive an input indicating a respective portion of the image. See operation 204. In another embodiment of the present invention, the apparatus may be configured to determine, by a processor, a location of the input within the image. See operation 206. Further still, another embodiment of the present invention may include causing information regarding the location of the input to be provided to the augmented reality device such that an indication may be imposed upon the view provided by the augmented reality device at the location of the input. See operation 208. The operations illustrated in and described with respect to FIG. 6 may, for example, be performed by, with the assistance of, and/or under the control of one or more of the processor 110, memory 112, communication interface 114, media capturing module 116, or augmented reality display 118.

FIG. 6 illustrates a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

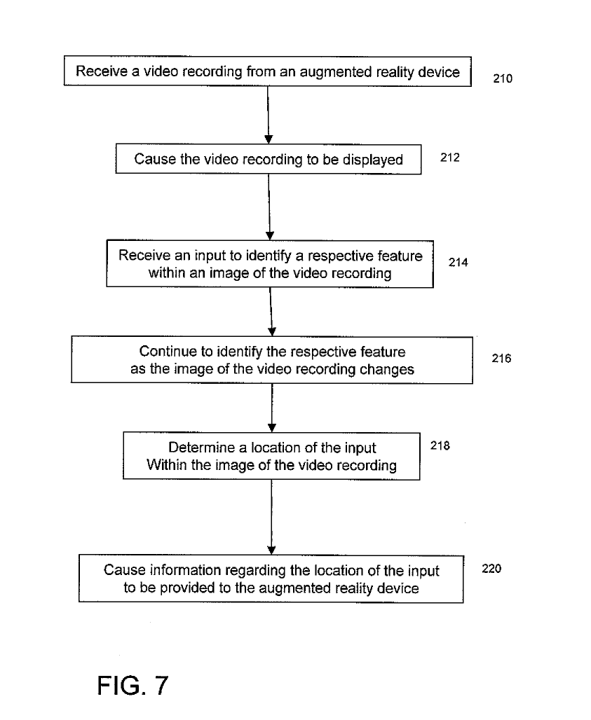

Referring now to FIG. 7, FIG. 7 illustrates an example interaction with an example augmented reality display and user interface according to an example embodiment. A user may engage an imaging device, such as an imaging device comprising an augmented reality glasses and a camera configured to visually record the forward field of view of the augmented reality glasses. One embodiment of the invention may include receiving video recording from an augmented reality device, such as augmented realty glasses and a video camera configured to visually record the forward field of view of the augmented reality glasses. See operation 210. Further, another embodiment may include causing the video recording to be displayed to a touch display and/or the like. See operation 212. A second user may then provide a touch input, touch gesture input and/or the like to the touch display, which may be configured to receive an input to identify a respective feature within an image of the video recording. See operation 214. In another embodiment of the present invention, the apparatus may be configured to continue to identify the respective feature as the image of the video recording changes. See operation 216. According to one embodiment, the apparatus may also be configured to determine, by a processor, a location of the input within the image of the video recording. See operation 218. Further still, another embodiment of the present invention may include causing information regarding the location of the input to be provided to the augmented reality device. See operation 220. The operations illustrated in and described with respect to FIG. 7 may, for example, be performed by, with the assistance of, and/or under the control of one or more of the processor 110, memory 112, communication interface 114, media capturing module 116, or augmented reality display 118.

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

Although described above in conjunction with an embodiment having a single augmented reality device 2 and a single user interface 3, a system in accordance with another embodiment of the present invention may include two or more augmented reality devices and/or two or more user interfaces. As such, a single user interface 3 may provide inputs that define icons or other indications to be presented upon the display of two or more augmented reality devices. Additionally or alternatively, a single augmented reality device may receive inputs from two or more user interfaces and may augment the image of its surroundings with icons or other indications defined by the multiple inputs. In one embodiment, the first and second users may each include an augmented reality device 2 and a user interface 3 so that each user can see not only its surroundings via the augmented reality display, but also an image from the augmented reality display of the other user. Additionally, each user of this embodiment can provide input via the user interface to define icons or other indications for display by the augmented reality device of the other user.

The above described functions may be carried out in many ways. For example, any suitable means for carrying out each of the functions described above may be employed to carry out embodiments of the invention. In one embodiment, the means for performing operations 200-206 of FIG. 6 and/or operations 210-218 of FIG. 7 may be a suitably configured processor (for example, the processor 110). In another embodiment, the means for performing operations 200-206 of FIG. 6 and/or operations 210-218 of FIG. 7 may be a computer program product that includes a computer-readable storage medium (for example, the memory 112), such as the non-volatile storage medium, and computer-readable program code portions, such as a series of computer instructions, embodied in the computer-readable storage medium.

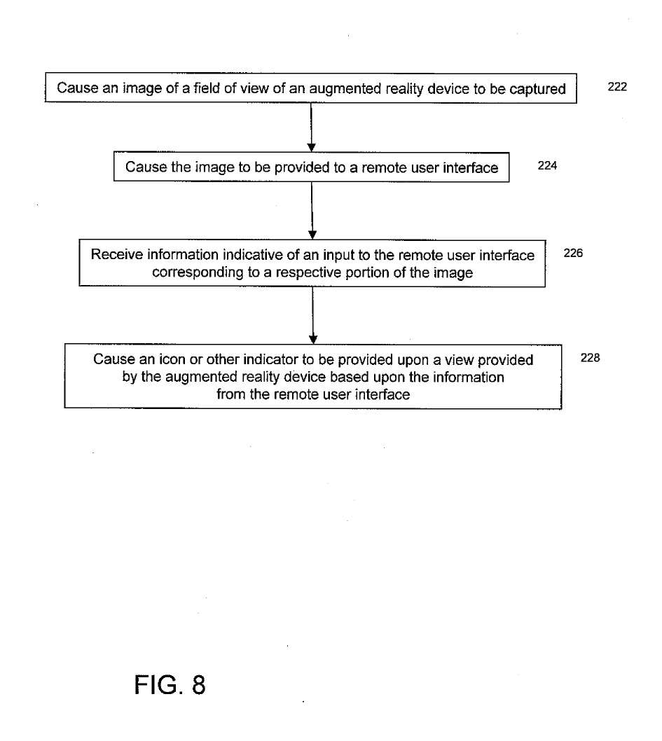

Referring now to FIG. 8, FIG. 8 illustrates an example interaction with an example augmented reality display according to an example embodiment. A user may engage an imaging device, such as an imaging device comprising an augmented reality glasses and a camera configured to visually record the forward field of view of the augmented reality glasses. One embodiment of the invention may include capturing an image of a field of view of an augmented reality device. See operation 222. Further, another embodiment may include causing the image to be provided to a remote user interface. See operation 224. A second user may then provide a touch input, touch gesture input and/or the like to the touch display, which may be configured to receive an input indicating a respective portion of the image. One embodiment of the present invention may include receiving the information indicative of a respective portion of the image. See operation 226. In another embodiment of the present invention, the apparatus may be configured to cause an icon or other indicator to be provided in conjunction with the image based upon the information from the remote user interface. See operation 228. The operations illustrated in and described with respect to FIG. 8 may, for example, be performed by, with the assistance of, and/or under the control of one or more of the processor 110, memory 112, communication interface 114, media capturing module 116, or augmented reality display 118.

The above described functions may be carried out in many ways. For example, any suitable means for carrying out each of the functions described above may be employed to carry out embodiments of the invention. In one embodiment, the means for performing operations 222-228 of FIG. 8 may be a suitably configured processor (for example, the processor 110). In another embodiment, the means for performing operations 222-228 of FIG. 7 may be a computer program product that includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving an image of a view of an augmented reality device;
causing the image to be displayed;
receiving an input indicating a respective portion of the image;
determining, by a processor, a location of the input within the image; and
causing information regarding the location of the input to be provided to the augmented reality device such that an indication may be imposed upon the view provided by the augmented reality device corresponding to the input.

2. An apparatus comprising at least one processor and at least one memory storing computer program code, wherein the at least one memory and stored computer program code are configured, with the at least one processor, to cause the apparatus to at least:
receive an image of a view of an augmented reality device;
cause the image to be displayed;
receive an input indicating a respective portion of the image;
determine, by a processor, a location of the input within the image; and
cause information regarding the location of the input to be provided to the augmented reality device such that an indication may be imposed upon the view provided by the augmented reality device at the location of the input.

3. The apparatus of claim 2, wherein the at least one processor and at least one memory storing computer program code are configured, with the at least one processor, to cause the apparatus to at least receive the image in real time so that the image that is caused to be displayed is also displayed by the augmented reality device.

4. The apparatus of claim 2, wherein the at least one processor and at least one memory storing computer program code are configured, with the at least one processor, to cause the apparatus to at least:
receive a video recording; and
cause the video recording to be displayed.

5. The apparatus of claim 4, wherein the at least one processor and at least one memory storing computer program code are configured, with the at least one processor, to cause the apparatus to receive the input to identify a respective feature within an image of the video recording and continue to identify the respective feature as the image changes.

6. The apparatus of claim 5, wherein the at least one processor and at least one memory storing computer program code are configured, with the at least one processor, to cause the apparatus to employ feature recognition to identify the respective feature within the video recording.

7. The apparatus of claim 2, wherein the at least one memory and stored computer program code are configured, with the at least one processor, to cause the apparatus to receive an input that moves across the image so as to indicate both a location and a direction.

8. A computer program product comprising at least one non-transitory computer-readable storage medium having computer-readable program instructions stored therein, the computer-readable program instructions comprising program instructions configured to cause an apparatus to perform a method comprising:
receiving an image of a view from an augmented reality device;
causing the image to be displayed;
receiving an input indicating a respective portion of the image;
determining, by a processor, a location of the input within the image; and
causing information regarding the location of the input to be provided to the augmented reality device such that an indication may be imposed upon the view provided by the augmented reality device at the location of the input.

9. The computer program product of claim 8 configured to cause an apparatus to perform a method further comprising receiving the image in real time so that the image that is caused to be displayed is also displayed by the augmented reality device.

10. The computer program product of claim 8 configured to cause an apparatus to perform a method further comprising:
receiving a video recording; and
causing the video recording to be displayed.

11. The computer program product of claim 10 configured to cause an apparatus to perform a method further comprising receiving the input to identify a respective feature within an image of the video recording and continuing to identify the respective feature as the image changes.

12. The computer program product of claim 11 configured to cause an apparatus to perform a method further comprising employing feature recognition to identify the respective feature within the video recording.

13. The computer program product of claim 8 configured to cause an apparatus to perform a method further comprising receiving an input that moves across the image so as to indicate both a location and a direction.

14. A method comprising:
causing an image of a field of view of an augmented reality device to be captured;
causing the image to be provided a remote user interface;
receiving information indicative of an input to the at least one remote user interface corresponding to a respective portion of the image; and
causing at least one indicator to be provided upon a view provided by the augmented reality device based upon the information from the remote user interface.

15. A method according to claim 14, wherein causing the image to be provided comprises causing the image to be provided to the remote user interface in real time.

16. A method according to claim 14, wherein causing an image of a field of view to be captured comprises causing a video recording to be captured, and wherein causing the image to be provided comprises causing the video recording to be provided to the remote user interface in real time.

17. A method according to claim 16, wherein receiving information indicative of an input to the remote user interface comprises receiving information indicative of an input to the remote user interface identifying a respective feature within an image of the video recording, and continuing to receive information indicative of an input to the remote user interface identifying the respective feature as the image changes.

18. A method according to claim 17, wherein continuing to receive information indicative of an input to the remote user interface identifying a respective feature comprises receiving information employing feature recognition to identify the respective feature within the video recording.

19. A method according to claim 14, wherein receiving information comprises receiving information indicative of an input to the remote user interface that moves across the image so as to indicate both a location and a direction.

20. An apparatus comprising at least one processor and at least one memory storing computer program code, wherein the at least one memory and stored computer program code are configured, with the at least one processor, to cause the apparatus to at least:
cause an image of a field of view of an augmented reality device to be captured;
cause the image to be provided to a remote user interface;
receive information indicative of an input to the remote user interface corresponding to a respective portion of the image; and
cause an indicator to be provided upon the view provided by the apparatus based upon the information from the remote user interface.

21. The apparatus of claim 20, wherein the at least one processor and at least one memory storing computer program code are configured, with the at least one processor, to cause the apparatus to at least cause the image to be provided to the remote user interface in real time.

22. The apparatus of claim 20, wherein the at least one processor and at least one memory storing computer program code are configured, with the at least one processor, to cause the apparatus to at least:
cause a video recording to be captured; and
cause the video recording to be provided to the remote user interface in real time.

23. The apparatus of claim 22, wherein the at least one processor and at least one memory storing computer program code are configured, with the at least one processor, to cause the apparatus to at least receive information indicative of an input to the remote user interface identifying a respective feature within an image of the video recording, and continue to receive information indicative of an input to the remote user interface identifying the respective feature as the image changes.

24. The apparatus of claim 23, wherein the at least one processor and at least one memory storing computer program code are configured, with the at least one processor, to cause the apparatus to at least receive information employing feature recognition to identify the respective feature within the video recording.

25. The apparatus of claim 20, wherein the at least one processor and at least one memory storing computer program code are configured, with the at least one processor, to cause the apparatus to at least receive information indicative of an input to the remote user interface that moves across the image so as to indicate both a location and a direction.

26. A computer program product comprising at least one non-transitory computer-readable storage medium having computer-readable program instructions stored therein, the computer-readable program instructions comprising program instructions configured to cause an apparatus to perform a method comprising:
causing an image of a field of view of an augmented reality device to be captured;
causing the image to be provided to a remote user interface;
receiving information indicative of an input to the remote user interface corresponding to a respective portion of the image; and
causing an indicator to be provided upon the view provided by the augmented reality device based upon the information from the remote user interface.

27. The computer program product of claim 26 configured to cause an apparatus to perform a method further comprising causing the image to be provided to the remote user interface in real time.

28. The computer program product of claim 26 configured to cause an apparatus to perform a method further comprising:
causing a video recording to be captured; and
causing the video recording to be provided to the remote user interface in real time.

29. The computer program product of claim 28 configured to cause an apparatus to perform a method further comprising receiving information indicative of an input to the remote user interface identifying a respective feature within an image of the video recording, and continuing to receive information indicative of an input identifying the respective feature as the image changes.

30. The computer program product of claim 29 configured to cause an apparatus to perform a method further comprising receiving information employing feature recognition to identify the respective feature within the video recording.

31. The computer program product of claim 26 configured to cause an apparatus to perform a method further comprising receiving information indicative of an input to the remote user interface that moves across the image so as to indicate both a location and a direction.
